(19) United States
(12) Patent Application Publication
(10) Pub. No.: US 2025/0203322 A1
(43) Pub. Date: Jun. 19, 2025

(54) DETERMINING A LOCATION OF A WIRELESS CALLER IN AN EMERGENCY SERVICING SYSTEM

(71) Applicant: DISH Wireless L.L.C., Englewood, CO (US)

(72) Inventors: Jeffrey Lang McSchooler, Parker, CO (US); Cary Allen Pearl, Aurora, CO (US)

(21) Appl. No.: 18/540,449

(22) Filed: Dec. 14, 2023

(51) Int. Cl. H04W 4/029; H04M 3/51

(52) U.S. Cl. CPC H04W 4/029; H04M 3/5116

(57) ABSTRACT

A user equipment (UE) receives a command to place a wireless voice call to an emergency service and, in response, initiates the wireless voice call to the emergency service at an emergency phone number. The UE detects that a connection is established between the UE and a PSAP, wherein the PSAP is responsible for dispatching emergency services. The UE determines a geolocation of the UE and transmits the determined geolocation to the PSAP.

### TECHNICAL FIELD

The present disclosure relates generally to wireless communications, and more specifically to determining a location of a wireless caller in an emergency servicing system.

### BACKGROUND

One of the primary challenges in providing emergency service to a wireless caller is to determine a location of the wireless caller quickly and accurately so that emergency services can be swiftly dispatched to the location of the wireless caller. In present emergency systems, when a wireless caller uses a wireless device to place an emergency call to an emergency phone number (e.g., 911), the call is routed to a public-safety answering point (PSAP) where an emergency service dispatcher answers the call. The PSAP receives a caller ID associated with the wireless device and an address of the cell tower to which the wireless device is connected. This information is not helpful as the wireless device may be hundreds of meters or even miles away from the cell tower to which the wireless device is connected. In some enhanced emergency systems (e.g., enhanced 911 (E-911) systems) the emergency dispatcher at the PSAP can manually transmit a digital request (also known as a “rebid” request) to the cellular network seeking the location of wireless device. In response to receiving the digital request, the cellular network determines and transmits an approximate location of the wireless device to the dispatcher's computer. This approximate location of the wireless device often does not provide accurate location information to the emergency dispatcher. Further, this process can result in long delays in providing the emergency dispatcher location data associated with the wireless caller. In many cases, this process returns no location data at all. In such cases, the only way the emergency dispatcher can determine the location of the wireless caller is by oral communication with the wireless caller, which may be prone to errors and not always practical (e.g., when the caller is unable to speak clearly or speak at all).

### SUMMARY

The system and methods implemented by the system as disclosed in the present disclosure provide an improved method for determining a geolocation of a wireless caller calling into an emergency service network. The disclosed system and methods provide several practical applications and technical advantages. For example, the disclosed system provides the practical application of determining quickly and accurately a location of a wireless caller calling into an emergency service network. As described in embodiments of the present disclosure, in response to receiving a command to place a wireless voice call to an emergency service network, a user equipment (UE) initiates the wireless voice call to the emergency service network at an emergency phone number. When the UE detects that a connection is established between the UE and a PSAP, the UE determines and transmits a geolocation of the UE to the PSAP over the connection established between the UE and the PSAP. Receiving the geolocation of the UE directly from the UE instead of receiving an approximate location of the UE from the cellular network, greatly improves location accuracy of the UE received at the PSAP and allows an emergency dispatcher to dispatch the needed emergency services to the correct location of the wireless caller. Further, as the UE automatically transmits the geolocation right after a connection is established with the PSAP, the PSAP receives the geolocation almost instantly. This allows the emergency dispatcher to dispatch emergency services to the wireless caller's location without delay which would otherwise be incurred in requesting and receiving location information from the cellular network.

The disclosed system and method provide the technical advantage of improving the overall network efficiency of the cellular network connected to the UE. Causing the UE to determine and transmit geolocation information to the PSAP saves the cellular network from receiving a location request from the PSAP, determining an approximate location of the UE, and transmitting the approximate location back to the PSAP. This saves network resources including processing resources, memory resources and network bandwidth, thus improving the efficiency of the cellular network.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with one embodiment of the present disclosure;

FIG. 2 is a flowchart of an example method for determining a location of a wireless caller calling into an emergency service network, in accordance with one embodiment of the present disclosure; and

FIG. 3 illustrates an example schematic diagram of the user equipment illustrated in FIG. 1, in accordance with one embodiment of the present disclosure.

### DETAILED DESCRIPTION

### System Overview

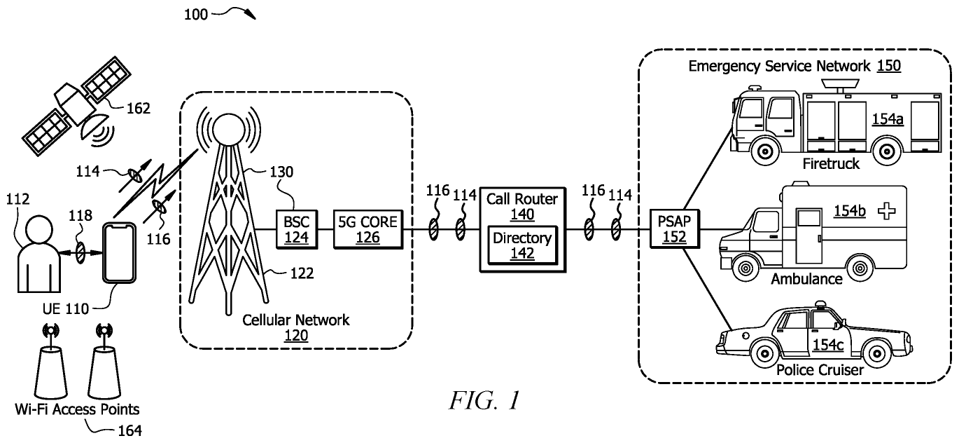

FIG. 1 is a schematic diagram of a system 100, in accordance with one embodiment of the present disclosure. As shown in FIG. 1, system 100 includes a user equipment (UE) 110, a cellular network 120, a call router 140, and an emergency service network 150. The cellular network 120 may further include a base station tower 122, a base station controller (BSC) 124, and a 5G core 126.

Collectively, base station tower 122 and base station controller 124 may be referred to as a base station 130. A base station tower 122, often also referred to as a cell tower, is a fixed radio transceiver that is capable of sending and receiving wireless signals and is the main communication point for UEs 110. It may be noted that the terms “base station tower”, “cell tower” and “tower” may be used interchangeably throughout this disclosure. BSC 124 is a network element that typically controls and monitors several base station towers 122 and provides an interface between a tower 122 and a mobile switching center (not shown). In the context of 5th Generation (5G) New Radio (NR), base station 130 may be referred to as a gNodeB or gNB. It may be noted that the terms “base station” and “gNodeB” may be used interchangeably throughout this disclosure. Base station 130 may provide the UE 110 access to the 5G core 126. For example, base station 130 may be part of a 5G NR cellular network. In this context, base station 130 may be a gNodeB. Base station 130 may serve a particular geographical area, with other base stations serving neighboring geographical areas that at least partially overlap. Services provided by the cellular network 120 can include telephone calls, network access (e.g., Internet access), data reporting, text messaging services, etc. Such services may generally rely on packetized data being exchanged between the UE 110 and the base station 130.

While cellular network 120 is described in the context of a 5G NR radio network that uses gNodeBs as base stations 130, the embodiments detailed herein can be applicable to other types of cellular networks, such as a 4G Long Term Evolution (LTE) cellular network, that uses cNodeBs in place of gNodeBs. In one or more embodiments, cellular network 120 operates according to the 5G NR radio access technology (RAT). In other embodiments, a different RAT may be used, such as 3G, 4G Long Term Evolution (LTE), or some other RAT. In some other embodiments, as shown in FIG. 1, the 5G network may use a 5G core 126. In some embodiments, a 5G network may use an evolved packet core (EPC) instead of or in addition to the 5G core 126. Communications from base station tower 122 to UE 110 may be scheduled. Various physical resource blocks (PRBs) may be available across multiple component carriers (CCs) of a carrier aggregation (CA) for communication. Each PRB may define a timeslot on a particular frequency within a CC. The number of PRBs available on a given CC is dependent on the bandwidth of the CC and the subcarrier spacing of the CC.

UE 110 can be one of various forms of wireless devices that are capable of communication according to the radio access technology (RAT) of the cellular network 120. For instance, UE 110 can be a smartphone, wireless modem, cellular phone, laptop computer, wireless access point (APs), etc.

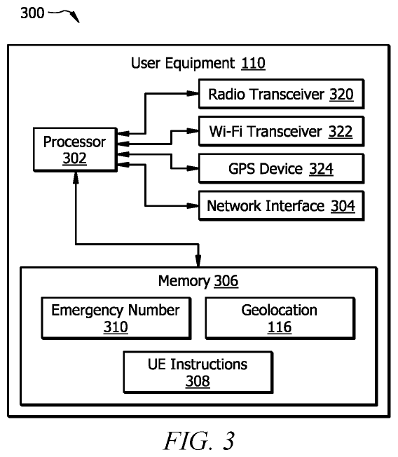

The emergency service network 150 generally includes a plurality of public-safety answering points (PSAPs). One such example PSAP 152 is shown in FIG. 1. A PSAP 152 is a call center where emergency calls initiated by a landline or mobile device (e.g., UE 110) are received. An example emergency service network 150 may include the 9-1-1 emergency service network that is used in United States and other countries across the globe. For example, several countries have their own version of the 9-1-1 emergency network to provide emergency services to their residents. The emergency service network 150 may have several PSAPs 152 deployed across a region (e.g., country), wherein each PSAP 152 serves a particular city, town, county, village, municipality or portions thereof and attends to emergency calls made from a location within a service area of the PSAP 152. For example, the United States has over 5000 PSAPs 152 spread across the nation. Callers needing emergency services call an emergency telephone number 310 (shown in FIG. 3) that is common across all PSAPs 152. Example emergency numbers 310 include 911 and 112 used in North American countries. Usually, calls made to the common emergency telephone number 310 are received at a call router 140 which is responsible to route the call to a PSAP 152 that is nearest to the caller's physical location. For example, each base station tower 122 is mapped to a particular PSAP 152 that is closest to the base station tower 122. Additionally, each PSAP 152 has a unique telephone number that may be used to reach the PSAP 152. When a wireless caller 112 uses a UE 110 to place a telephone call 114 to the common emergency telephone number 310, the call 114 is first received at the call router 140 along with an identity of the base station tower 122 that is currently connected to the UE 110. The call router 140 maintains a directory 142 of mappings between base station radio towers 122 and closest PSAPs 152. The call router 140 looks up the directory 142 and identifies a PSAP 152 that is mapped to the particular tower 122 that is currently connected to the UE 110. The call router 140 then routes the call 114 to the identified PSAP 152 by connecting/forwarding the call 114 to the particular telephone number of the identified PSAP 152. An emergency dispatcher at the PSAP 152 receives the call 114 and dispatches one or more emergency services 154 to the location of the wireless caller 112. Example emergency services 154 may include one or more fire trucks 154a, one or more ambulances 154b, one or more police cars 154c or combinations thereof. It may be noted that the call router 140 may be a stand alone entity or may be integrated with the cellular network 120. For example, the automatic call routing service provided by the call router 140 may be provided by a third-party provider or by an operator of the cellular network 120.

One of the primary challenges in providing emergency service to a wireless caller 112 is to determine a location of the wireless caller 112 quickly and accurately so that emergency services 154 can be swiftly dispatched to the location of the wireless caller 112. In present emergency systems, when a wireless caller 112 uses a UE 110 to place an emergency call 114 to the emergency phone number 310 and the call 114 is connected to a PSAP 152, the PSAP 152 receives a caller ID associated with the UE officially known as the automatic number identification (ANI) and an address associated with the base station tower 122 that is connecting the call 114. However, the address of the base station tower 122 is not helpful as the UE 110 may be hundreds of meters or even miles away from the base station tower 122 to which the UE 110 is connected. In some enhanced emergency systems (e.g., enhanced 911 (E-911) systems) the emergency dispatcher at the PSAP 152 who receives the call 114 can manually transmit a digital request (also known as a “rebid” request) to the cellular network 120 seeking the location of UE 110. In response to receiving the digital request, the cellular network 120 attempts to determine the location of the UE 110 using network triangulation and trilateration to gain an approximate location of the UE 110 and sends back the approximate location to the dispatcher's computer. This approximate location of the UE 110 determined by the cellular network 120 may be within 300 meters of the nearest base station tower 122, and thus, often does not provide accurate location information to the emergency dispatcher. Further, this process can result in long delays in providing the emergency dispatcher location data associated with the wireless caller 112. In many cases, this process returns no location data at all. In such cases, the only way the emergency dispatcher can determine the location of the wireless caller 112 is by oral communication with the wireless caller 112, which may be prone to errors and not always practical (e.g., when the caller 112 is unable to speak clearly or speak at all).

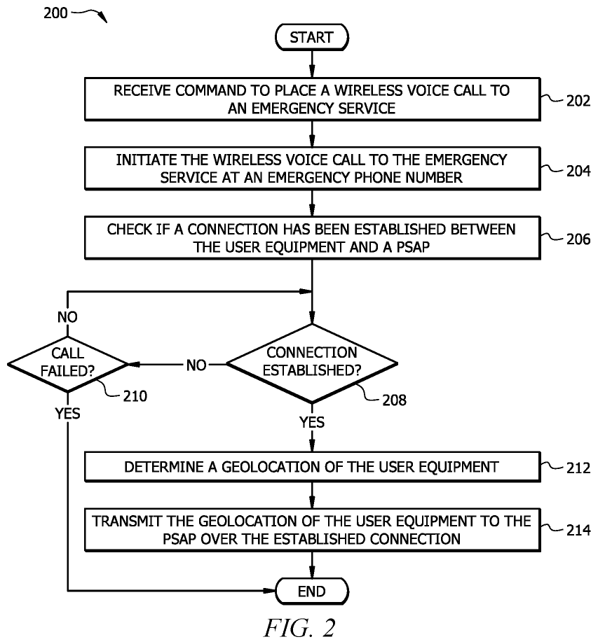

Embodiments of the present disclosure describe techniques for determining quickly and accurately a location of a wireless caller 112 calling into an emergency service network 150. FIG. 2 is a flowchart of an example method 200 for determining a location of a wireless caller 112 calling into an emergency service network 150, in accordance with one embodiment of the present disclosure. Method 200 may be performed by the UE 110 as shown in FIG. 1 and FIG. 3.

At operation 202, the UE 110 receives a command 118 to place a wireless voice call 114 to an emergency service network 150. In one embodiment, the command 118 may be received from a wireless caller 112. For example, the wireless caller may manually dial or select an emergency telephone number 310 (e.g., 911) on a smartphone to generate the command 118. In a second embodiment, the command 118 may be automatically generated by the UE 110 based on a pre-configured trigger event. For example, the wireless caller's smartphone may be connected to a medical device that monitors one or more pre-set parameters (e.g., heart rate, pulse etc.) associated with the wireless caller's health. The wireless caller's smartphone may be configured to automatically generate the command 118 in response to detecting that one or more of the pre-set parameters are outside their respective thresholds.

At operation 204, in response to receiving the command 118, UE 110 initiates a wireless call 114 to the emergency service network 150 at the emergency telephone number 310 (e.g., 911). In one or more embodiments, UE 110 may include a radio transceiver 320 (shown in FIG. 3) that is configured to exchange radio signals with a base station tower 122. The UE 110 may be configured to use the radio transceiver 320 to search for a closest base station tower 122 associated with a cellular network 120 and connect to the cellular network via the base station tower 122.

In an alternative embodiment, the UE 110 may be configured to initiate a wireless call 114 to the emergency service network 150 using satellite communication. UE 110 may be capable of communicating with a communication satellite (not shown). For example, UE 110 may be a satellite telephone which is a type of mobile phone that connects to a telephone network (e.g., cellular network 120) by radio link through satellites orbiting the Earth instead of terrestrial base stations such as base station 130. In this embodiment, the UE 110 initiates a wireless call 114 to the emergency service network 150 at the emergency telephone number 310 (e.g., 911), which includes establishing a wireless connection with the cellular network 120 (e.g., 5G Core 126) via one or more communication satellites.

At operation 206, UE 110 checks whether a connection has been established between the UE 110 and a PSAP 152 associated with the emergency service network 150. A connection is generally established between the UE 110 and a computer at the PSAP 152 and is generally determined to have been established when an emergency dispatcher at the PSAP 152 answers the wireless call 114 using the dispatcher's computer. The dispatcher's computer generally includes or is communicatively coupled to a device that allows the dispatcher to exchange voice and data with the UE 110 over the cellular network 120. In certain embodiments, the UE 110 establishes a voice connection as well as a data connection with the PSAP 152 (e.g., dispatcher's computer). This allows the UE 110 to exchange data with the PSAP 152 in addition to engaging in a voice all 114 with the PSAP 152. As described further below, the UE 110 may leverage the data connection with the PSAP 152 to send information related to geolocation 116 associated with the UE 110. It may be noted that present emergency systems do not allow any direct data connection between a UE 110 and the PSAP 152. As described above, wireless calls 114 made to the common emergency telephone number 310 are received at a call router 140 which is responsible to route the call to a PSAP 152 that is nearest to the caller's physical location. For example, each base station tower 122 is mapped to a particular PSAP 152 that is closest to the base station tower 122. Additionally, each PSAP 152 has a unique telephone number that may be used to reach the PSAP 152. When the wireless caller 112 uses the UE 110 to place the wireless telephone call 114 to the emergency telephone number 310, the wireless call 114 is first received at the call router 140 along with an identity of the base station tower 122 that is currently connected to the UE 110. The call router 140 maintains a directory 142 of mappings between cell towers 122 and closest PSAPs 152. The call router 140 look up the directory 142 and identifies that PSAP 152 is mapped to the base station tower 122 that is currently connected to the UE 110. The call router 140 then routes the wireless call 114 to the identified PSAP 152 by connecting/forwarding the call 114 to the particular telephone number of the identified PSAP 152. As described above, a connection (e.g., including a voice connection and data connection) is established between the UE 110 and a computer of the emergency dispatcher who answers the wireless call 114 at the PSAP 152.

It may be noted that method 200 applies to text messages sent from the UE 110 to the emergency service network 150. For example, in response to receiving the command 118, UE 110 may transmit a text message to the emergency service network 150 at a designated emergency telephone number (e.g., emergency number 310). In response to receiving the text message from the UE 110, a designated/selected PSAP 152 may respond to the text message by transmitting a response text message back to the UE 110. The UE 110 may then establish a data connection with the PSAP 152 (e.g., dispatcher's computer) using which the UE 110 may transmit information related to geolocation 116 associated with the UE 110.

At operation 208, UE 110 checks whether a connection is successfully established between the UE 110 and the PSAP 152. In response to detecting that a connection is not established, the method 200 proceeds to operation 210 where the UE 110 checks if the wireless call 114 has failed. In response to detecting that the wireless call 114 has failed, method 200 ends here. On the other hand, in response to detecting that the wireless call 114 has not failed, method 200 moves back to operation 206 where the UE 110 continues to check whether a connection has been established between the UE 110 and the PSAP 152.

In response to detecting at operation 208 that a connection is successfully established between the UE 110 and the PSAP 152, method 200 proceeds to operation 212 where the UE 110 determines a geolocation 116 of the UE 110. The UE 110 may determine the geolocation of the UE 110 by performing global positioning system (GPS) positioning using a GPS device, by performing radio location with one or more cell towers 122, by performing Wi-Fi positioning with one or more Wi-Fi access points, or combinations thereof. In one embodiment, UE 110 may include a GPS device 324 (shown in FIG. 3). GPS device 324 is configured to capture and to provide information relating to the geolocation 116 of the UE 110 based on interaction with one or more GPS satellites 162. GPS device 324 may be configured to provide the geolocation 116 information as a relative geographic location or an absolute geographic location. GPS device 324 may provide the geolocation 116 information using geographic coordinates (i.e., longitude and latitude) or any other suitable coordinate system.

In an additional or alternative embodiment, UE 110 may be configured to determine the geolocation 116 of the UE 110 by performing radiolocation using the radio transceiver 320. Radiolocation generally is the process of finding a geographical location of an object using radio waves. Radiolocation is used in cellular telephony via cell towers 122. Several radiolocation methods may be used to determine geolocation 116 of the UE 110 including, but not limited to trilateration, multilateration, triangulation or combinations thereof.

In an additional or alternative embodiment, UE 110 may be configured to determine the geolocation 116 of the UE 110 by performing Wi-Fi positioning using nearby Wi-Fi access points 164. Wi-Fi positioning system (WPS) is a geolocation system that uses the characteristics of nearby Wi-Fi hotspots and other wireless access points 164 to discover where a device (e.g., UE 110) is located. Determining geolocation 116 of the UE 110 using Wi-Fi positioning generally includes measuring the intensity of signals received from one or more nearby Wi-Fi access points and determining a geo-location of the UE 110 by correlating the signal strengths with known positions of the Wi-Fi access points.

It may be noted that the UE 110 may be configured to determine the geolocation 116 of the UE at any point during method 200. For example, the UE 110 may determine the geolocation 116 of the UE in response to receiving the command 118 to place the wireless call 114, in response to detecting that the wireless call 114 has been initiated and/or in response to determining that a connection has been established between the UE 110 and the PSAP 152.

At operation 214, UE 110 may transmit the geolocation 116 of the UE 110 to the PSAP 152, for example, over the data connection established between the UE 110 and the PSAP 152. In one embodiment, the UE 110 may be configured to transmit the geolocation 116 of the UE 110 to the PSAP 152 in response to determining that a connection has been established between the UE 110 and the PSAP 152. As described above, the UE 110 may pre-determine the geolocation 116 of the UE 110 before a connection is established between the UE 110 and the PSAP 152. This allows the UE 110 to transmit the geolocation 116 to the PSAP 152 soon after the connection is established without much delay.

In one or more embodiments, after transmitting the geolocation 116 of the UE 110 to the PSAP 152, UE 110 may periodically update the geolocation 116 to reflect a more recent geolocation 116 of the UE 110. UE 110 may transmit an updated geolocation 116 to the PSAP 152 after performing each such update. This is especially helpful when the wireless caller 112 is moving, for example, in a vehicle and allows the emergency dispatcher to track a current location of the wireless caller 112.

In one embodiment, the UE 110 may be configured to provide information relating to the geolocation 116 of the UE 110 to a software application (e.g., mobile app installed at the UE 110 or running on a web server on the internet) that is configured to analyze geolocation data and determine an accurate geographical location of the UE 110 based on the analysis. For example, the UE 110 may provide (e.g., transmit) GPS coordinates of the UE 110 to the software application, which may determine a physical address nearest to the provided GPS coordinates. This location information (e.g., physical address) is then transmitted to the PSAP 152.

It may be noted that receiving the geolocation 116 of the UE 110 directly from the UE 110 instead of receiving an approximate location of the UE 110 from the cellular network 120, greatly improves location accuracy of the UE 110 received at the PSAP 152 and allows an emergency dispatcher to dispatch the needed emergency services to the correct location of the wireless caller 112. Further, as the UE 110 automatically transmits the geolocation 116 right after a connection is established with the PSAP 152, the PSAP 152 receives the geolocation 116 almost instantly. This allows the emergency dispatcher to dispatch emergency services to the wireless caller's location without delay which would otherwise be incurred in requesting and receiving location information from the cellular network 120.

FIG. 3 illustrates an example schematic diagram of the UE 110 illustrated in FIG. 1, in accordance with one embodiment of the present disclosure.

UE 110 includes a processor 302, a memory 306, a network interface 304, a radio transceiver 320, a Wi-Fi transceiver 322, and a GPS device 324. The UE 110 may be configured as shown in FIG. 3 or in any other suitable configuration.

The processor 302 comprises one or more processors operably coupled to the memory 306. The processor 302 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 302 may be a programmable logic device, a microcontroller, a microprocessor, or any suitable combination of the preceding. The processor 302 is communicatively coupled to and in signal communication with the memory 306. The one or more processors are configured to process data and may be implemented in hardware or software. For example, the processor 302 may be 8-bit, 16-bit, 32-bit, 64-bit or of any other suitable architecture. The processor 302 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute software instructions (e.g., UE instructions 308) to implement the UE 110. In this way, processor 302 may be a special-purpose computer designed to implement the functions disclosed herein. In one or more embodiments, the UE 110 is implemented using logic units, FPGAs, ASICs, DSPs, or any other suitable hardware. The UE 110 is configured to operate as described with reference to FIGS. 1-2. For example, the processor 302 may be configured to perform at least a portion of the method 200 as described in FIG. 2.

The memory 306 comprises one or more non-transitory computer-readable medium devices such as disks, tape drives, or solid-state drives, and may be used as an over-flow data storage device, to store programs when such programs are selected for execution, and to store instructions and data that are read during program execution. The memory 306 may be volatile or non-volatile and may comprise a read-only memory (ROM), random-access memory (RAM), ternary content-addressable memory (TCAM), dynamic random-access memory (DRAM), and static random-access memory (SRAM).

The memory 306 is operable to store emergency phone number 310, geolocation 116, and the UE instructions 308. The UE instructions 308 may include any suitable set of instructions, logic, rules, or code operable to execute the UE 110.

The network interface 304 is configured to enable wired and/or wireless communications. The network interface 304 is configured to communicate data between the UE 110 and other devices, systems, or domains (e.g., base station 130). For example, the network interface 304 may comprise a Wi-Fi interface, a LAN interface, a WAN interface, a modem, a switch, or a router. The processor 302 is configured to send and receive data using the network interface 304. The network interface 304 may be configured to use any suitable type of communication protocol as would be appreciated by one of ordinary skill in the art.

It may be noted that one or more of the base station controller 124, call router 140 and PSAP 152 may be implemented similar to the UE 110. For example, each of the base station controller 124, call router 140 and PSAP 152 may include a processor and a memory storing instructions to implement the respective functionality when executed by the processor.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. A user equipment, comprising:
a radio transceiver; and
a processor communicatively coupled to the radio transceiver and configured to:
receive a command to place a wireless voice call to an emergency service;
in response to receiving the command, initiate the wireless voice call to the emergency service at an emergency phone number using the radio transceiver;
detect that a connection has been established between the user equipment and a Public-Safety Answering Point (PSAP), wherein the PSAP is responsible for dispatching emergency services;
determine a geolocation of the user equipment; and
in response to detecting that the connection has been established between the user equipment and the PSAP, transmit the geolocation of the user equipment to the PSAP.

2. The user equipment of claim 1, wherein the processor is further configured to:
after transmitting the geolocation of the user equipment to the PSAP, periodically update the geolocation to reflect a more recent geolocation of the user equipment; and
transmit an updated geolocation to the PSAP after performing each update.

3. The user equipment of claim 1, wherein the processor is further configured to determine the geolocation of the user equipment in response to detecting that the connection has been established between the user equipment and the PSAP.

4. The user equipment of claim 1, wherein the processor is configured to determine the geolocation of the user equipment by performing radio location with one or more radio towers.

5. The user equipment of claim 1, further comprising:
a Wi-Fi transceiver configured to exchange data with one or more Wi-Fi access points; and
wherein the processor is further configured to determine the geolocation of the user equipment by performing Wi-Fi positioning using the one or more Wi-Fi access points.

6. The user equipment of claim 1, further comprising:
a Global Positioning System (GPS) device configured to determine GPS coordinates; and
wherein the processor is further configured to determine the geolocation of the user equipment by determining the GPS coordinates of the user equipment using the GPS device.

7. The user equipment of claim 1, wherein the emergency service comprises the 9-1-1 emergency service.

8. A method for determining a geolocation of a user equipment, comprising:
receiving a command to place a wireless voice call to an emergency service;
in response to receiving the command, initiating the wireless voice call to the emergency service at an emergency phone number using a radio transceiver;
detecting that a connection has been established between the user equipment and a Public-Safety Answering Point (PSAP), wherein the PSAP is responsible for dispatching emergency services;
determining the geolocation of the user equipment; and
in response to detecting that the connection has been established between the user equipment and the PSAP, transmitting the geolocation of the user equipment to the PSAP.

9. The method of claim 8, further comprising:
after transmitting the geolocation of the user equipment to the PSAP, periodically update the geolocation to reflect a more recent geolocation of the user equipment; and
transmit an updated geolocation to the PSAP after performing each update.

10. The method of claim 8, wherein determining the geolocation of the user equipment is in response to detecting that the connection has been established between the user equipment and the PSAP.

11. The method of claim 8, wherein determining the geolocation of the user equipment comprises performing radio location with one or more radio towers.

12. The method of claim 8, further comprising:
determining the geolocation of the user equipment by performing Wi-Fi positioning using one or more Wi-Fi access points.

13. The method of claim 8, further comprising:
determining the geolocation of the user equipment by determining Global Positioning System (GPS) coordinates of the user equipment using a GPS device.

14. The method of claim 8, wherein the emergency service comprises the 9-1-1 emergency service.

15. A non-transitory computer-readable medium storing instructions that when executed by a processor cause the processor to:
receive, at a user equipment, a command to place a wireless voice call to an emergency service;
in response to receiving the command, initiate the wireless voice call to the emergency service at an emergency phone number using a radio transceiver;
detect that a connection has been established between the user equipment and a Public-Safety Answering Point (PSAP), wherein the PSAP is responsible for dispatching emergency services;
determine a geolocation of the user equipment; and
in response to detecting that the connection has been established between the user equipment and the PSAP, transmit the geolocation of the user equipment to the PSAP.

16. The non-transitory computer-readable medium of claim 15, wherein the instructions further cause the processor to:
after transmitting the geolocation of the user equipment to the PSAP, periodically update the geolocation to reflect a more recent geolocation of the user equipment; and
transmit an updated geolocation to the PSAP after performing each update.

17. The non-transitory computer-readable medium of claim 15, wherein determining the geolocation of the user equipment is in response to detecting that the connection has been established between the user equipment and the PSAP.

18. The non-transitory computer-readable medium of claim 15, wherein determining the geolocation of the user equipment comprises performing radio location with one or more radio towers.

19. The non-transitory computer-readable medium of claim 15, wherein the instructions further cause the processor to determine the geolocation of the user equipment by performing Wi-Fi positioning using one or more Wi-Fi access points.

20. The non-transitory computer-readable medium of claim 15, wherein the instructions further cause the processor to determine the geolocation of the user equipment by determining Global Positioning System (GPS) coordinates of the user equipment using a GPS device.
